(19) United States
(12) Patent Application Publication
(10) Pub. No.: US 2026/0202703 A1
(43) Pub. Date: Jul. 16, 2026

(54) GLAZING ELEMENT WITH ELECTRICAL FUNCTIONAL ELEMENT

(71) Applicant: SAINT-GOBAIN SEKURIT FRANCE, THOUROTTE (FR)

(72) Inventors: Muhammed Nasuh ALTIN, HERZOGENRATH (DE); Viktor SEIBEL, HERZOGENRATH (DE); Michael LABROT, HERZOGENRATH (DE)

(21) Appl. No.: 19/137,936

(22) PCT Filed: Oct. 18, 2023
(86) PCT No.: PCT/EP2023/078903

§ 371 Date: Jun. 11, 2025

(30) Foreign Application Priority Data
Dec. 12, 2022 (EP) 22212839.9

(51) Int. Cl. G02F 1/1339; B32B 7/12; B32B 17/10; B60J 3/04; G02F 1/161; G02F 1/169

(52) U.S. Cl. CPC G02F 1/1339; B32B 7/12; B32B 17/10036; B32B 17/10504; B32B 17/10513; B60J 3/04; G02F 1/161; G02F 1/169; B32B 2307/7376; B32B 2605/00

(57) ABSTRACT

A glazing element includes a glass pane or plastic pane and an encapsulation layer on a surface of the glass pane or plastic pane, wherein the encapsulation layer is formed at least in some regions as a layer of an optically clear adhesive and wherein an electrical functional element is arranged between the layer of the optically clear adhesive and the glass pane or plastic pane or is embedded in the layer of the optically clear adhesive.

The invention relates to a glazing element having an integrated electrical functional element, a method for the production thereof, and the use thereof.

It is known that glazing elements can be equipped with electrical functional elements. The glazing elements are usually formed as laminated panes, consisting of two glass panes and a thermoplastic intermediate layer located between them, wherein the functional element is embedded in the intermediate layer. The intermediate layer is often formed from at least two thermoplastic foils, in particular PVB foils, between which the functional element is positioned and thereby embedded in the intermediate layer. Such laminated windows with integrated functional elements are particularly common in the field of vehicle panes—for example, as windscreens or roof panes. The electrical functional elements can, for example, be sensors of various types (such as light sensors or rain sensors), light-emitting diodes, or functional foils with electrically controllable optical properties, which can be used in particular to electrically control the transparency of the laminated pane. Examples of this are SPD, PDLC, or electrochromic functional foils. Laminated panes of this type are known, for example, from WO2014029536A1, WO2014086555A1, or WO2017157626A1.

The laminated panes are typically produced using so-called autoclave methods, with which the glass panes are laminated together at high temperature and high pressure via the thermoplastic interlayer. These conditions place a high load on the typically sensitive electrical functional elements. For example, optical distortions can be generated as a result of tensions occurring, or the functional elements can even be damaged.

Therefore, there is a need for glazing elements and methods for their production that have integrated electrical functional elements, wherein a high optical quality is ensured, the functional elements are protected against damage, and which can be produced in a manner that is gentle on the functional element.

US20180155575A1 discloses a glazing element with which an electrical functional element is fastened to a glass pane via an adhesive layer made of an optically clear adhesive (OCA). Accordingly, the adhesive layer is arranged between the glass pane and the functional element.

The present invention is based upon the object of providing an improved glazing element having an integrated electrical functional element, and a gentle method for the production thereof. The glazing element should have a high optical quality, and the functional element should be protected against damage.

The object of the present invention is achieved by a glazing element according to claim 1. Preferred embodiments result from the dependent claims.

The glazing element according to the invention comprises at least one glass pane or plastic pane and an encapsulation layer on a surface of the glass pane or plastic pane. The encapsulation layer is formed as a layer of optically clear adhesive, at least in some regions. An electrical functional element is arranged between the layer of optically clear adhesive and the glass pane or plastic pane, or embedded in the layer of optically clear adhesive.

Due to the layer of an optically clear adhesive, the functional element can be embedded with high optical quality into the glazing element. The functional element is mechanically stably integrated into the glazing element and protected from damage caused by external influences. The layer of an optically clear adhesive can be produced by a casting method, which is gentle on the functional element because no high pressures or temperatures occur, as is common in the lamination of laminated panes (particularly in autoclave processes). These are great advantages of the present invention.

For the sake of simplicity, the glass or plastic pane is also referred to below simply as the “pane” or “primary pane” (to distinguish it from any further panes of the glazing element). The glass or plastic pane has two main surfaces, which are provided for seeing through and are arranged substantially parallel to one another, and a side edge surface running between them. The encapsulation layer is arranged on one of the main surfaces of the pane, in particular over the entire surface. The pane can be flat or curved, wherein both cylindrical and spherical bends are possible. Spherically curved glazing elements are typically found in the automotive sector in particular, whereas flat glazing elements are predominantly used in the architectural sector. Both flat and curved glazing elements are common in rail vehicles, ships, and large construction or agricultural vehicles.

The primary task of the encapsulation layer is to integrate the functional element securely and mechanically stably into the glazing element and to protect it from damage. The encapsulation layer can also fulfil further tasks, such as connecting the glass or plastic pane to a further glass or plastic pane (in the manner of a laminated pane), if such a further pane is provided. In particular, the encapsulation layer covers the entire surface (main surface) of the glass or plastic pane.

The encapsulation layer is formed as a layer of optically clear adhesive, at least in some regions. This means that there is at least one region of the glazing element in which the encapsulation layer is formed by said layer of optically clear adhesive, and indeed over its entire thickness. The encapsulation layer can be formed as a layer of optically clear adhesive. However, it is also possible that only one region or a plurality of regions of the encapsulation layer is or are formed as a layer of the optically clear adhesive, whereas a further region or a plurality of further regions are formed in a different way—for example, by a thermoplastic foil. In other words, the encapsulation layer is in some regions formed as a layer of optically clear adhesive, and in some regions composed of other materials, in particular at least one thermoplastic foil. The regions are arranged next to one another in relation to the see-through direction through the glazing element. The layer of optically clear adhesive and any further elements (e.g., thermoplastic foils) extend over the entire thickness of the encapsulation layer in each case. The regions with the layer of optically clear adhesive are transparent (i.e., allow seeing through), whereas the further regions can be either transparent or opaque.

The encapsulation layer preferably has a thickness of 0.2 mm to 50 mm, particularly preferably of 0.5 mm to 2 mm.

Optically clear adhesives (OCA's) are known as such to a person skilled in the art. They are characterised in particular by their high optical quality. They are particularly common where high optical quality is required, so that the adhesive layer is virtually invisible—for example, in displays or touch panels. Optically clear adhesives are characterised in particular by their high light transmission and the fact that they allow seeing through without distortion. For the sake of simplicity, the layer of an optically clear adhesive according to the invention is also referred to below as the OCA layer.

The optically clear adhesive is preferably a 2-component polyurethane adhesive, a 1-component acrylate adhesive, a 1-component silicone adhesive, or a 1-component acrylate hybrid adhesive.

The external surfaces of the glazing element are parallel to one another, so that the glazing element has a constant overall thickness. The external surfaces of the glazing element can be formed from the surfaces, facing away from one another, of the glass or plastic pane and the encapsulation layer, if the glazing element is structurally composed only of the glass or plastic pane and the encapsulation layer. Further glass or plastic panes can also be connected to said glass or plastic panes and/or the encapsulation layer, which then in turn support the external surfaces of the glazing element, as will be explained in more detail below when presenting the preferred embodiments. The external surfaces are the exposed surfaces of the glazing element, which are in contact with the surrounding atmosphere and can be touched, wherein it is not excluded that the external surfaces are provided with transparent coatings, in particular formed from thin layers. The encapsulation layer also has two main surfaces provided for seeing through and a side edge surface running between them. The main surfaces are arranged parallel to the main surfaces of the primary pane (and also to the main surfaces of any further panes of the glazing element).

The electrical functional element can be fastened to the surface of the primary pane—for example, via an adhesive or a thermoplastic foil. It is then arranged between the OCA layer and the primary pane. Alternatively, the functional element can be embedded in the OCA layer, so that it is completely surrounded by the optically clear adhesive. In each case, the glazing element comprises the primary pane, the electrical functional element on a surface of the primary pane, and optically clear adhesive (all or part of the OCA layer) above the electrical functional element, i.e., on the side, facing away from the primary pane, of the functional element.

In a first basic embodiment of the glazing element, the surface, facing away from the primary pane, of the encapsulation layer forms one of the two external or exposed surfaces of the glazing element. In other words, the encapsulation layer is an external layer of the glazing element whose surface facing away from the primary pane is not connected to a further structural element, in particular a further glass or plastic pane. Such a glazing element has an advantageously low weight.

In the first basic embodiment, the encapsulation layer is preferably formed entirely as a layer of the optically clear adhesive. In an advantageous further development, a transparent protective coating is arranged on the external surface, facing away from the primary pane, of the encapsulation layer or the OCA layer. The protective coating serves in particular to protect the OCA layer from scratching (scratch protection layer).

The invention further comprises a method for producing the glazing element according to the first basic embodiment, wherein
(a) the primary pane and a support pane are arranged parallel to and at a distance from one another, so that a cavity is formed between them,
(b) the cavity is then provided with an edge seal,
(c) an optically clear adhesive is then filled into the cavity and cured, and
(d) the support pane is then removed again.

The functional element is
arranged (preferably fixed with an adhesive or a thermoplastic foil) on the surface, facing the support pane, of the primary pane prior to method step (a) or
arranged in the cavity, wherein it is distanced from both the primary pane and the support pane and is not in direct contact with either of them.

The support pane can be made of glass, plastic, ceramic, metal, or wood, for example, i.e., it can be a glass pane, a plastic pane, a ceramic pane, a metal plate, or a wooden plate.

In principle, a support pane in the narrower sense of a pane or plate-like object does not necessarily have to be used. In general, any support shape can be used, wherein the surface of the support shape, which surface faces the primary pane and the cavity and determines the shape of the surface, facing away from the primary pane, of the encapsulation layer, is parallel to the main surfaces of the primary pane. However, the use of a support pane is preferred, in particular because they are easy to handle, and the same production apparatuses can be used as in the production of the glazing element according to the second basic embodiment (wherein the secondary pane is used instead of the support pane).

In an advantageous embodiment of the method, on the surface, facing the primary pane, of the support pane, a layer (separating layer) is arranged which is suitable for preventing adhesion between the support pane and the optically clear plastic. As a result, removing the support pane after the adhesive has cured is facilitated. The separating layer is preferably a Teflon layer, which is permanently applied to the surface of the support pane, or a Teflon foil, which is applied to the surface of the support pane.

In a second basic embodiment of the glazing element, the encapsulation layer is arranged between the primary pane and a further glass pane or plastic pane. This further glass or plastic pane connected to the encapsulation layer is also referred to below as the “secondary pane”. The encapsulation layer connects the primary pane with the secondary pane in the manner of a laminated pane. This embodiment can have the advantage of greater mechanical stability, and the encapsulation layer is protected from damage between the primary pane and secondary pane. In addition, the glazing element has a greater structural analogy to a conventional laminated pane, so that it is sometimes better accepted by the customer and can more easily replace conventional laminated panes.

The invention further comprises a method for producing the glazing element according to the second basic embodiment, wherein
(a) the primary pane and the secondary pane are arranged parallel to and at a distance from one another, so that (at least) one cavity is formed between them,
(b) the cavity is then provided with an edge seal,
(c) an optically clear adhesive is then filled into the cavity and cured.

The Functional Element is
arranged (preferably fixed with an adhesive or a thermoplastic foil) on the surface, facing the secondary pane, of the primary pane prior to method step (a) or
arranged in the cavity, wherein it is distanced from both the primary pane and the secondary pane and is not in direct contact with either of them.

The secondary pane can be the only structural element arranged on the surface, facing away from the primary pane, of the encapsulation layer. In other words, the glazing element contains the primary pane, the encapsulation layer thereon, and a single pane thereon (specifically, the secondary pane). In this case, the surface, facing away from the encapsulation layer, of the secondary pane is one of the two external or exposed surfaces of the glazing element. The secondary pane, if it is formed as a glass pane, is preferably thermally pretensioned.

Alternatively, the secondary pane can be connected to a further glass pane or plastic pane via a thermoplastic intermediate layer. More precisely, the surface, facing away from the encapsulation layer, of the secondary pane is connected to the further glass or plastic pane via the intermediate layer. In other words, the glazing element contains the primary pane, the encapsulation layer thereon, and a laminated pane that is composed of the secondary pane, a further pane, and a thermoplastic intermediate layer located therebetween, wherein the secondary pane faces the encapsulation layer. In this case, the surface, facing away from the secondary pane and the thermoplastic intermediate layer, of said further pane is one of the two external or exposed surfaces of the glazing element.

If the secondary pane is to be connected to a further pane via a thermoplastic intermediate layer as described above, the laminated pane consisting of the secondary pane, the intermediate layer, and the further pane is preferably produced prior to the method described above, with which the encapsulation layer is formed between the primary pane and secondary pane. For producing the laminated pane, known methods, e.g., autoclave methods, vacuum bag methods, vacuum ring methods, calender methods, vacuum laminators, or combinations thereof, may be used for this purpose. The connection of the panes via the intermediate layer is usually done under the influence of heat, vacuum, and/or pressure.

In principle, the secondary pane can also be part of a laminated pane consisting of more than two panes, wherein, in turn, at least one further pane is attached on the side, facing away from the secondary pane, of the further pane. In each case, neighbouring panes are connected to one another via a thermoplastic intermediate layer. The surface, facing away from the secondary pane, of the pane farthest from the secondary pane forms one of the two external or exposed surfaces of the glazing element.

The secondary pane can also be connected to a further glass or plastic pane via a spacer to form an insulating glazing unit, wherein the space between the panes is filled with an inert gas or is evacuated.

In a first variant of the second basic embodiment, the encapsulation layer is formed entirely as a layer of the optically clear adhesive. In a second variant of the second basic embodiment, the encapsulation layer is formed in some regions as a layer of the optically clear adhesive and in some regions from at least one thermoplastic foil (i.e., from one thermoplastic foil or a stack of several thermoplastic foils). The encapsulation layer thus has at least one region in which it is formed over its entire thickness as an OCA layer, and at least one further region in which it is formed over its entire thickness from the at least one thermoplastic foil.

Said second variant of the second basic embodiment can be particularly advantageous if the functional element or the functional elements are integrated only in local regions of the glazing element, whereas other regions have no functional element or are equipped with less sensitive functional elements. The encapsulation layer can then be formed in the regions with the functional element, using the OCA layer according to the invention, and in the regions without the functional element or with the less sensitive functional elements, using the at least one thermoplastic foil (in the latter case, said less sensitive functional elements can be embedded between two thermoplastic foils, for example). Thus, the glazing element can sometimes be produced more cost-effectively, because the entire encapsulation layer is not formed by the comparatively expensive optically clear adhesive. It is possible that the glazing element has at least one transparent see-through region and at least one opaque masking region. In this case, it may be preferable if the encapsulation layer is formed as an OCA layer with the functional element in the see-through region and is made of the thermoplastic foil in the masking region. Such a masking region can be realised, for example, by an opaque cover imprintment on one of the panes of the glazing element or by using an opaque thermoplastic foil.

In the production of such a glazing element, the primary pane and the secondary pane are preferably initially locally connected to one another via the thermoplastic foil. Known methods, e.g., autoclave methods, vacuum bag methods, vacuum ring methods, calender methods, vacuum laminators, or combinations thereof, can be used for this purpose. The connection is carried out, for example, locally via one or more strips of the thermoplastic foil. The connection of the panes is typically achieved under the influence of heat, vacuum, and/or pressure. This corresponds to method step (a) in the method described above: The primary pane and secondary pane are then arranged parallel to and at a distance from one another, wherein at least one cavity is formed in the region or regions without thermoplastic foil. This cavity must not be closed, i.e., the thermoplastic foil must not extend circumferentially around the cavity. The space between the panes is then provided with an edge seal (method step (b)), and an optically clear adhesive is filled into the at least one cavity and cured (method step (c)). The functional element is arranged beforehand in the at least one cavity or is already fixed to the surface of the primary pane via the thermoplastic foil prior to lamination.

The primary pane can be the only pane that is attached to the corresponding side of the encapsulation layer. In other words, the glazing element contains a single pane (specifically, the primary pane), the encapsulation layer thereon, and optionally the secondary pane thereon (which may also be present as a single pane or may be connected to one or more further panes, as described above). In this case, the surface, facing away from the encapsulation layer, of the primary pane is one of the two external or exposed surfaces of the glazing element. The primary pane is preferably thermally pretensioned if it is formed as a glass pane.

Alternatively, the primary pane can be connected to a further glass pane or plastic pane via a thermoplastic intermediate layer. More precisely, the surface, facing away from the encapsulation layer, of the primary pane is connected to the further glass or plastic pane via the intermediate layer. In other words, the glazing element contains a laminated pane that is composed of the primary pane, a further pane, and a thermoplastic intermediate layer located between them, the encapsulation layer on the primary pane, and optionally the secondary pane thereon (which can also be present as a single pane or can be connected to one or more further panes, as described above). In this case, the surface, facing away from the primary pane and the thermoplastic intermediate layer, of said further pane is one of the two external or exposed surfaces of the glazing element.

If the primary pane is to be connected to a further pane via a thermoplastic intermediate layer as described above, the laminated pane consisting of the primary pane, the intermediate layer, and the further pane is preferably produced prior to the method described above, with which the encapsulation layer is formed between the primary pane and the support pane or secondary pane. For producing the laminated pane, known methods, e.g., autoclave methods, vacuum bag methods, vacuum ring methods, calender methods, vacuum laminators, or combinations thereof, may be used for this purpose. The connection of the panes via the intermediate layer is usually done under the influence of heat, vacuum, and/or pressure.

In principle, the primary pane can also be part of a laminated pane consisting of more than two panes, wherein, in turn, at least one further pane is attached to the side, facing away from the secondary pane, of the further pane. In each case, neighbouring panes are connected to one another via a thermoplastic intermediate layer. The surface, facing away from the primary pane, of the pane farthest from the primary pane, forms one of the two external or exposed surfaces of the glazing element.

The primary pane can also be connected to a further glass or plastic pane via a spacer to form an insulating glazing unit, wherein the space between the panes is filled with an inert gas or is evacuated.

The following remarks on the production method relate equally to the methods for producing the glazing element according to the two basic embodiments.

The cavity between the primary pane and the support pane or secondary pane is formed by the intermediate space between said panes if they are arranged parallel to and at a distance from one another (or a part thereof if the two panes (in particular, the primary pane and secondary pane) are additionally connected to one another locally via a thermoplastic foil). This cavity is provided with an edge seal. The edge seal runs circumferentially along the side edge surfaces of the pair of panes and (partially) seals the cavity, wherein at least one opening remains, through which the optical clear adhesive can then be filled, preferably via a nozzle. The edge seal can be formed as an adhesive tape, for example, which is fastened to the side edge surfaces of the two panes. Alternatively, the pair of panes can be used in a suitable mould, which serves as an edge seal. Alternatively, the edge seal can be formed from a longitudinally slotted tube, for example, which is slipped over the edge region of the pair of panes, wherein the edge region is arranged in the slot (similar to the tube in the vacuum ring method for producing laminated panes).

In the production of the second basic embodiment of the glazing element, it is not necessary to use an edge seal that is later removed. Instead, an edge seal can be used which is arranged between the primary pane and the secondary pane in the edge region and remains permanently in the glazing element. Such a permanent edge seal can be made of PVB or polyurethane, for example.

If the functional element is arranged on the surface of the primary pane, it is arranged between the primary pane and the encapsulation layer after the formation of the encapsulation layer. The functional element can be fixed to the surface using an adhesive or a thermoplastic foil, for example. If the primary pane is arranged below the support pane or secondary pane, the functional element can also simply be placed on the surface. If the functional element is arranged inside the cavity, wherein it is at a distance from both panes, it is embedded in the encapsulation layer after the formation of the encapsulation layer. The functional element can be arranged in the cavity, for example, by means of suitable support elements or suspensions (for example, made of threads, rods, or a grid), by means of which the functional element is held in place (at a distance from both panes) as long as the optically clear adhesive is still liquid. The support elements or suspensions can be removed, for example, if the viscosity of the adhesive has decreased sufficiently to fix the functional element, but is still high enough to allow non-destructive removal of the support elements or suspension. However, the support elements or elements of the suspension can also remain in the glazing element, in particular if they are arranged in an opaque region of the glazing element, which is formed, for example, by an opaque cover imprintment on a surface of at least one of the panes of the glazing element.

The optically clear adhesive is filled into the cavity in liquid form (liquid optically clear adhesive, LOCA; LOCA liquid adhesive) and subsequently cured. The primary pane and the secondary pane or the support pane can, for example, be arranged horizontally or vertically when the adhesive is filled in. The optically clear adhesive can be cured in any manner, and depends upon the type of adhesive used. For example, UV-curing or thermally curing adhesives can be used. 2-component adhesives, which cure as a result of chemical reactions, can also be used.

In an advantageous embodiment, the functional element is provided pre-encapsulated in optically clear adhesive. A layer of the optically clear adhesive is thus provided, into which the functional element is embedded, so that at least the surface facing the primary pane and the surface, facing away from the primary pane, of the functional element is covered with optically clear adhesive, and preferably the functional element is completely surrounded by optically clear adhesive. The functional element pre-encapsulated in this way is then arranged on the surface of the primary pane (preferably fixed with an adhesive or a thermoplastic foil) or arranged in the cavity, and the cavity is subsequently filled with optically clear adhesive. The same optically clear adhesive is preferably used to pre-encapsulate the functional element and fill the cavity.

For producing the pre-encapsulation, the functional element can be arranged in a hollow mould (for example, with the aid of support elements or suspensions), this hollow mould can then be filled with optically clear adhesive, and the adhesive can then be cured. The surface, facing the functional element, of the hollow mould is preferably provided with a separating layer (coated with Teflon, for example) in order to be able to remove the pre-encapsulated functional element. For removing the pre-encapsulated functional element, for example, it can simply be pulled out of the hollow mould, or the hollow mould can be opened.

In a preferred embodiment of the glazing element according to the invention, the electrical functional element is a functional foil with electrically controllable optical properties. In principle, such functional foils are composed of a multilayer foil consisting of a first carrier foil, a first surface electrode, an active layer or layer sequence, a second surface electrode, and a second carrier foil, which are arranged on top of one another in the specified order. The carrier foils are made of polyethylene terephthalate (PET), for example, and have a thickness of 0.1 mm to 1 mm, preferably of 0.1 mm to 0.5 mm. The surface electrodes are formed, for example, as layers based upon a metal (in particular, silver) or a transparent, electrically conductive oxide (TCO; in particular, indium tin oxide (ITO)) with a thickness of 10 nm to 2 μm, preferably of 20 nm to 1 μm. The active layer or layer sequence depends upon the type of functional foil. It has electrically controllable optical properties, which can be controlled by applying a voltage to the surface electrodes.

The functional foil can be an SPD foil. SPD functional foils contain an active layer between the surface electrodes, which contains suspended particles that are preferably embedded in a viscous matrix. The absorption of light by the active layer can be varied by applying a voltage on the planar electrodes, which results in a change in orientation of the suspended particles.

The functional foil can be a foil based upon liquid crystal technology. Such functional foils contain an active layer with liquid crystals. The liquid crystals can be aligned by applying a voltage to the surface electrodes, which is the basis for the electrical control of the optical properties. The functional foil can be a PDLC foil, for example. The active layer contains drops of liquid crystals in a polymer network. If the liquid crystals are aligned in an electric field, the state is transparent and not light-scattering; if the liquid crystals are not aligned without an electric field, the state is translucent and strongly light-scattering. Alternatively, the functional foil can be a so-called guest-host foil, for example. The active layer contains dichroic dye molecules (guest) dissolved in liquid crystals (host). The liquid crystals are aligned in the electric field, as a result of which the orientation of the dye molecules is influenced, which results in a changed transmission level (tinting level) and a changed colour. Experience has shown that guest-host foils are particularly sensitive, such that the present invention is particularly advantageous in this respect.

The functional foil can be an electrochromic foil. Electrochromic functional foils contain an active layer sequence between the surface electrodes (electrochromic layer sequence), which is arranged in the following order: an ion storage layer, an electrolyte layer, and an electrochromic layer. The electrochromic layer is the actual bearer of the electrically controllable optical properties. It is an electrochemically active layer whose degree of light transmission is dependent upon the degree of ion storage. The ions (for example, H⁺—, Li⁺, Na⁺—, or K⁺ ions) are stored in and provided by the ion storage layer. The electrolyte layer separates the electrochromic layer spatially from the ion storage layer and serves to migrate ions. If a DC voltage of suitable polarity is applied to the planar electrodes, ions will migrate from the ion storage layer, through the electrolyte layer, and into the electrochromic layer, whereupon the optical properties (colour, light transmission) of the electrochromic layer are changed depending upon the quantity of ions that have migrated into said layer. If DC voltage of the opposite polarity is applied to the planar electrodes, the ions will migrate from the electrochromic layer, through the electrolyte layer, and back into the ion storage layer, and the optical properties of the electrochromic layer change in the opposite manner. If no voltage is applied to the planar electrodes, the current state will remain stable. Suitable electrochromic layers contain electrochromic materials, e.g., inorganic oxides (such as tungsten oxide or vanadium oxide), complex compounds (such as Prussian blue), or conductive polymers (such as 3,4-polyethylene dioxythiophene (PEDOT) or polyaniline). The electrolyte layer is typically designed as a film of organic or inorganic, electrically insulating material with a high degree of ion conductivity—for example, based upon lithium phosphorus oxynitride. The ion storage layer is either permanently transparent (pure ion storage) or has electrochromic behaviour opposite that of the electrochromic layer. One example of pure ion storage is that of layers containing a mixed oxide of titanium and cerium; examples of anodically electrochromic ion storage layers are layers containing iridium oxide or nickel oxide.

In a further preferred embodiment of the glazing element according to the invention, the electrical functional element is a sensor. Examples of sensors are photodiodes (as light sensors), rain sensors (capacitive or optical), and temperature sensors.

In a further preferred embodiment of the glazing element according to the invention, the electrical functional element is a light source. Light emitting diodes (LED's) are particularly suitable for this.

If the glazing element comprises one or more glass panes, they are preferably made of soda lime glass, as is common for window panes. In principle, however, other types of glass, e.g., quartz glass, borosilicate glass, or aluminosilicate glass, can also be used as an alternative. If the glazing element comprises one or more plastic panes, they are preferably made of a transparent and rigid polymer, particularly preferably polycarbonate (PC) or polymethyl methacrylate (PMMA). These statements refer equally to the primary pane and to any secondary pane and any further panes that are connected to the primary pane or the secondary pane. The material of the different panes can be selected independently of one another. All panes are preferably transparent. All panes have two main surfaces, which are provided for seeing through and are arranged substantially parallel to one another, and a side edge surface running between them.

The thickness of the primary pane, any secondary pane, and any further panes that are connected to the primary pane or the secondary pane is preferably between 0.5 mm and 5 mm in each case.

The panes can be provided with a coating—for example, an anti-reflective coating, an IR-reflective coating, or a heatable coating. Plastic panes are preferably provided with a protective coating to protect them from scratches (scratch protection layer).

The panes can be clear independently of one another, i.e., without tinting or colouring, or they can be tinted or coloured. In particular, if the glazing element is provided as building glazing, the panes are preferably clear. For vehicle glazing, it may be preferable if at least one of the panes is tinted or coloured.

Thermoplastic foils, which are used, for example, in order to laminate the primary pane and/or the secondary pane with a further pane to form a laminated pane (wherein the thermoplastic foil forms the intermediate layer) or to connect the primary pane to the secondary pane in some regions, are preferably based upon polyvinyl butyral (PVB), ethylene vinyl acetate (EVA), or polyurethane (PU), particularly preferably based upon PVB. This means that the film predominantly contains said material (more than 50 wt. %) and can, in addition, optionally contain further components—for example, plasticizers, stabilizers, UV- or IR-absorbers. The thickness of the thermoplastic foils is preferably 0.2 mm to 1 mm.

In addition to at least one transparent see-through region, the glazing element can optionally have at least one opaque masking region. Such a masking region is created in particular by integrating an opaque element into the glazing element, which prevents seeing through it. Preferably, this is an opaque cover imprintment on at least one surface of at least one pane of the glazing element. In the case of a glass pane, enamel prints are commonly used, which contain glass frits and a pigment (particularly, black pigment) and are baked into the glass surface.

The invention also comprises the use of a glazing element according to the invention in buildings or in means of transportation for traffic on land, in the air, or on water, preferably as a vehicle pane. The glazing element is used primarily in the automotive or architectural sector, in particular as a window pane in a vehicle, a building or an interior, in furniture or other furnishings, or as a furnishing item.

The invention is explained in more detail with reference to drawings and exemplary embodiments. The drawing is a schematic representation and is not true to scale. The drawing does not limit the invention in any way. In the drawings:

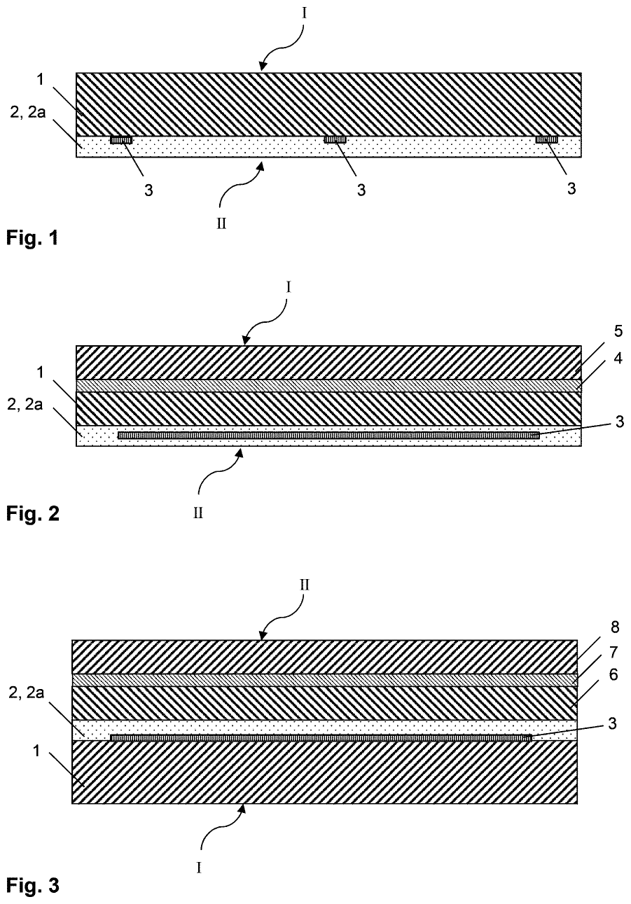

FIG. 1 is a cross-section through a first embodiment of a glazing element according to the invention,

FIG. 2 is a cross-section through a second embodiment of a glazing element according to the invention,

FIG. 3 is a cross-section through a third embodiment of a glazing element according to the invention,

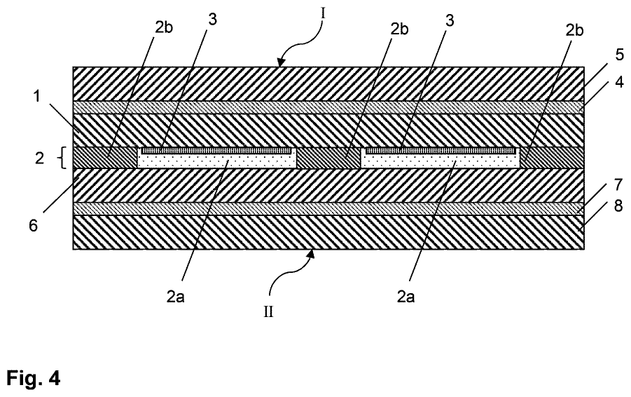

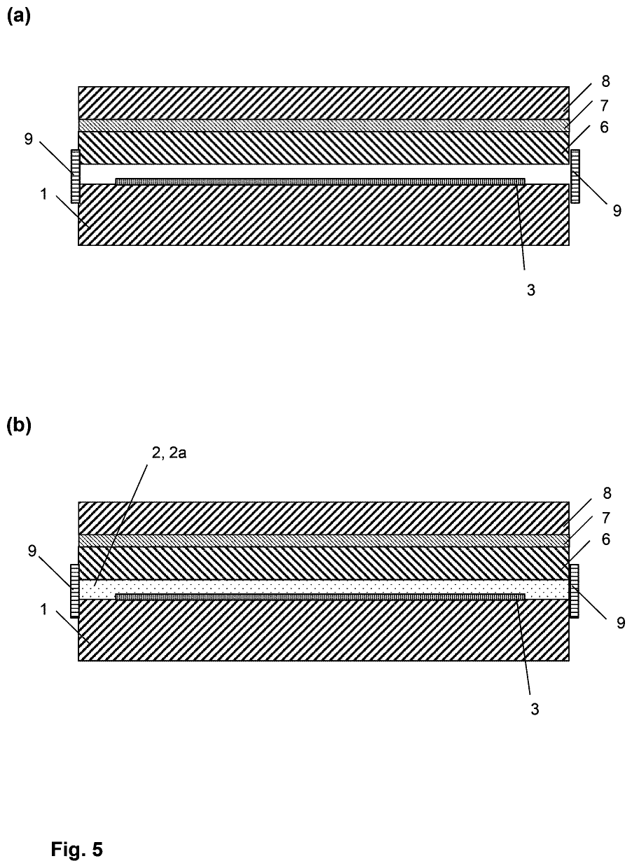

FIG. 4 is a cross-section through a fourth embodiment of a glazing element according to the invention,

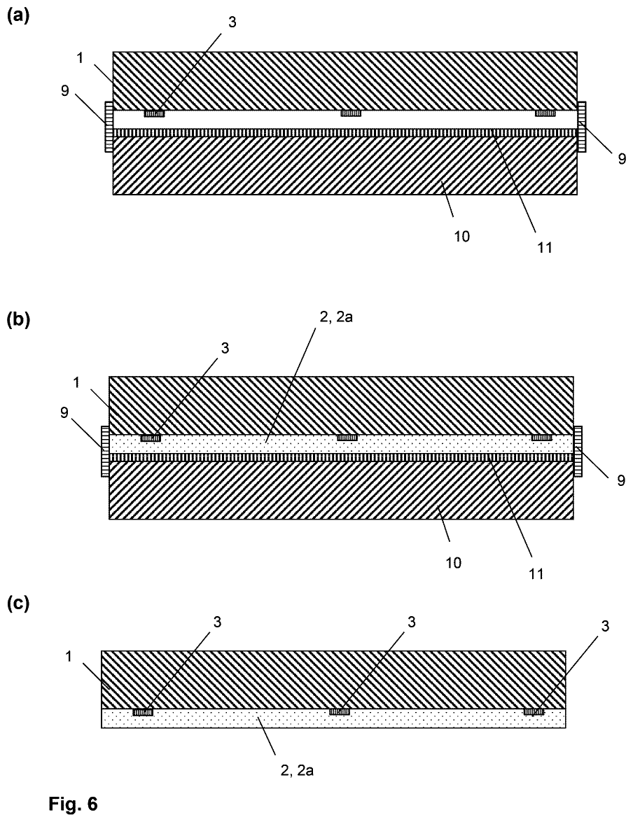

FIG. 5 shows cross-sections through an embodiment of the glazing element according to the invention at different points in time of an embodiment of the method according to the invention for the production thereof,

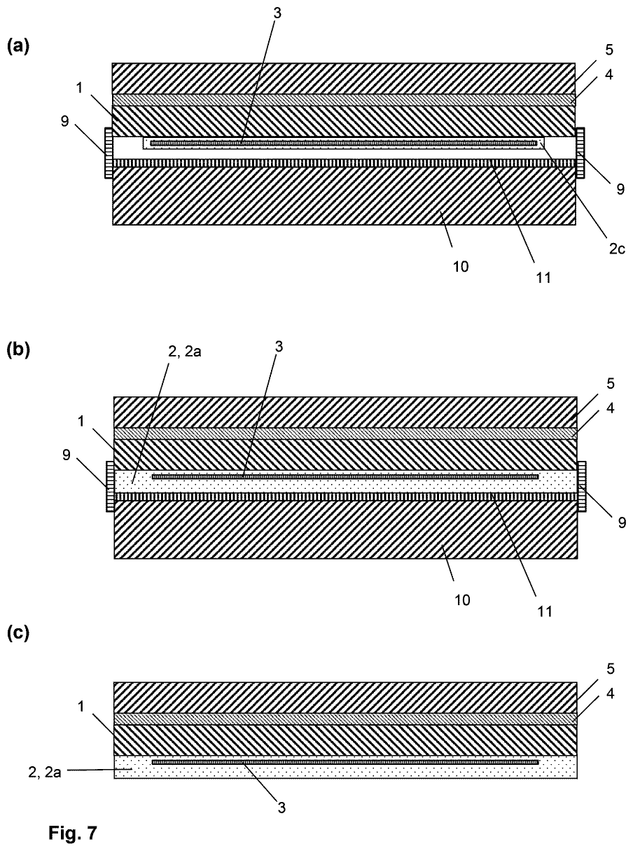

FIG. 6 shows cross-sections through an embodiment of the glazing element according to the invention at different points in time of a further embodiment of the method according to the invention for the production thereof,

FIG. 7 shows cross-sections through an embodiment of the glazing element according to the invention at different points in time of a further embodiment of the method according to the invention for the production thereof.

FIG. 1 shows a cross-section through an embodiment of the glazing element according to the invention. The glazing element is formed from a single glass pane 1, wherein an encapsulation layer 2 is arranged over the entire surface (main surface) of the glass pane 1. Three electrical functional elements 3 are arranged between the glass pane 1 and the encapsulation layer 2.

The glass pane 1, for example, is a thermally pretensioned pane made of soda lime glass with a thickness of 3.5 mm. The encapsulation layer 2 is formed entirely as the layer 2a of an optically clear adhesive (OCA). The optically clear adhesive, for example, is a 2-component polyurethane adhesive. The encapsulation layer, for example, has a thickness of 0.5 mm to 1 mm. The functional elements 3 are light-emitting diodes, for example.

The surface, facing away from the encapsulation layer 2, of the glass pane 1 forms a first external surface I of the glazing element; the surface, facing away from the glass pane 1, of the encapsulation layer 2 forms a second external surface II. The external surfaces I, II are aligned completely parallel to one another.

The glazing element can, for example, be provided as the roof pane of a vehicle, wherein the light-emitting diodes serve to illuminate the vehicle interior. Such a vehicle pane is typically curved, even if the glazing element is shown flat for the sake of simplicity.

FIG. 2 shows a cross-section through a further embodiment of the glazing element according to the invention. The glazing element is formed from a laminated pane, which consists of a glass pane 1 (primary pane), a further glass pane 5, and a thermoplastic intermediate layer 4 between them, wherein an encapsulation layer 2 is arranged over the entire surface (main surface) of the glass pane 1. An electrical functional element 3 is embedded in the encapsulation layer 2.

The glass panel 1 and the further glass panel 5 are, for example, panels made of soda lime glass, with a thickness of 2.1 mm in each case. The encapsulation layer 2 is formed entirely as the layer 2a of an optically clear adhesive (OCA). The optically clear adhesive, for example, is a 2-component polyurethane adhesive. The encapsulation layer has, for example, a thickness of 0.5 mm to 1 mm.

The functional element 3 is, for example, a functional foil with electrically controllable optical properties, with which the transparency of the glazing element can be electrically controlled. It is completely surrounded by the layer 2a of the optically clear adhesive.

The surface, facing away from the encapsulation layer 2 and the glass pane 1, of the further glass pane 5 forms a first external surface I of the glazing element; the surface, facing away from the glass pane 1, of the encapsulation layer 2 forms a second external surface II. The external surfaces I, II are aligned completely parallel to one another.

The glazing element can, for example, be provided as the roof pane of a vehicle, the transparency of which can be reduced by means of the functional element 3 in order to prevent glare from the sunlight or to slow down the heating of the interior. Such a vehicle pane is typically curved, even if the glazing element is shown flat for the sake of simplicity.

FIG. 3 shows a cross-section through a further embodiment of the glazing element according to the invention. The glazing element comprises a glass pane 1 (primary pane), an encapsulation layer 2, a further glass pane 6 (secondary pane), a thermoplastic intermediate layer 7, and a further glass pane 8.

The glass pane 1, for example, is a thermally pretensioned pane made of soda lime glass with a thickness of 3.5 mm. The further glass panes 6, 8 are, for example, panes of soda lime glass with a thickness of 2.1 mm in each case, which are laminated to form a laminated pane using a PVB foil with a thickness of 0.76 mm, which forms the intermediate layer 7. The encapsulation layer 2 is formed entirely as the layer 2a of an optically clear adhesive (OCA). It is arranged between the glass pane 1 and the further glass pane 6, and connects the two. The optically clear adhesive, for example, is a 2-component polyurethane adhesive.

A functional element 3 is arranged between the glass pane 1 and the encapsulation layer 2. The functional element 3 is connected to the surface of the glass pane 1 with an adhesive layer, for example, which is not shown. The functional element 3 is, for example, a functional foil with electrically controllable optical properties, with which the transparency of the glazing element can be electrically controlled.

The surface, facing away from the encapsulation layer 2, of the glass pane 1 forms a first external surface I of the glazing element; the surface, facing away from the further glass pane 6, of the further glass pane 8 forms a second external surface II. The external surfaces I, II are aligned completely parallel to one another.

This glazing element can also be used, for example, as a roof pane of a vehicle.

FIG. 4 shows a cross-section through a further embodiment of the glazing element according to the invention. This glazing element also comprises an encapsulation layer 2, which is arranged between a glass pane 1 (primary pane) and a further glass pane 6 (secondary pane) and connects the two to one another. The glass pane 1 is connected to a further glass pane 5 via a thermoplastic intermediate layer 4 to form a laminated pane. The further glass pane 6 is also connected to a further glass pane 8 via a thermoplastic intermediate layer 7 to form a laminated pane. All glass panes 1, 5, 6, 8, for example, are panes of soda lime glass with a thickness of 2.1 mm in each case. The intermediate layers 4, 7, for example, are in each case formed from a PVB foil with a thickness of 0.76 mm.

The encapsulation layer 2 is formed in some regions as a layer 2a of an optically clear adhesive (OCA) and in some regions from a thermoplastic foil 2b. The thermoplastic foil is a PVB foil, for example. The optically clear adhesive, for example, is a 2-component polyurethane adhesive.

A functional element 3 is arranged between the glass pane 1 and each layer 2a of the optically clear adhesive. The functional elements 3 are connected to the surface of the glass pane 1 with a layer of adhesive, for example, which is not shown. The functional elements 3 are, for example, a functional foil with electrically controllable optical properties that can be used to electrically control the transparency of the glazing element.

The surface, facing away from the glass pane 1, of the further glass pane 5 forms a first external surface I of the glazing element; the surface, facing away from the further glass pane 6, of the further glass pane 8 forms a second external surface II. The external surfaces I, II are aligned completely parallel to one another.

This glazing element can also be used, for example, as a roof pane of a vehicle. The regions with the layers 2a can be transparent regions of the roof pane, the transparency of which can be electrically controlled by means of the functional elements 3. The regions with the foils 2b can, for example, be opaque regions of the roof pane, wherein seeing through, for example, a black cover imprintment on a surface of one of the glass panes 1, 5, 6, 8 is prevented.

FIG. 5 shows cross-sections through the glazing element of FIG. 3 at different points in time of a method according to the invention for the production thereof. The laminated pane consisting of a further glass pane 6 (secondary pane), a thermoplastic intermediate layer 7, and a further glass pane 8 is provided already pre-laminated. The functional element 3 is fixed to one surface of the glass pane 1 (primary pane). The laminated pane is arranged parallel to the glass pane 1 (primary pane) and at a distance from it, wherein the glass pane 6 (secondary pane) and the surface, provided with the functional element 3, of the glass pane 1 (primary pane) face one another. The space between the panes forms a cavity.

Said cavity or space between the panes is subsequently provided with an edge seal 9 (FIG. 5a). The edge seal 9 is an adhesive tape, for example, which is fastened to the side edge surfaces of the glass pane 1 and the further glass pane 6, and thus seals off the space between the panes. The edge seal is applied circumferentially, wherein an opening in the cavity is left. Subsequently, the cavity is completely filled with an optically clear adhesive via this opening. The optically clear adhesive is then cured (for example, by means of UV radiation), resulting in the layer 2a of the optically clear adhesive, which in turn forms the encapsulation layer 2 (FIG. 5b). After removing the edge seal 9, the glazing element shown in FIG. 3 is created.

An edge seal 9 can also be used, which remains permanently in the glazing element. Such a permanent edge seal 9 is preferably arranged in the edge region of the glazing element between the glass pane 1 and the glass pane 6 and is formed from polyurethane, for example.

FIG. 6 shows cross-sections through the glazing element of FIG. 1 at different points in time of a method according to the invention for the production thereof. The functional elements 3 are fixed to the surface of the glass pane 1. The glass pane 1 is arranged parallel to and at a distance from a support pane 10, wherein the surface, provided with the functional element 3, of the glass pane 1 faces the support pane 10. The space between the panes forms a cavity. The support pane, for example, is also a 3.5 mm-thick pane made of soda lime glass. A separating layer 11, e.g., a Teflon foil, is arranged on the surface, facing the glass pane 1, of the support pane 10.

Subsequently, the cavity or space between the panes is sealed with an edge seal 9 (FIG. 6a)—for example, an adhesive tape. The optically clear adhesive is then filled into the cavity and cured, resulting in the layer 2a of the optically clear adhesive, which in turn forms the encapsulation layer 2 (FIG. 6b).

After removing the edge seal 9, the support pane 10 having the separating layer 11 can be removed. This is easily possible because the separating layer prevents adhesion between the support pane 10 and the encapsulation layer 2. The result is the glazing element from FIG. 1 (FIG. 6c).

FIG. 7 shows cross-sections through a further glazing element at different points in time of a method according to the invention for the production thereof. Similar to the embodiment shown in FIG. 2, the functional element 2 is to be embedded in the layer 2a of the optically clear adhesive, the glass pane 1 (primary pane) be part of a laminated glass, and the surface, facing away from the glass pane 1, of the encapsulation layer form an external surface of the glazing element.

The laminated pane consisting of the glass pane 1, the further glass pane 5, and an intermediate thermoplastic layer 4 is provided pre-laminated. The functional element 3 is provided pre-encapsulated, wherein the functional element 3 (a functional foil with electrically controllable optical properties) is completely surrounded by a pre-encapsulation 2c made of an optically clear adhesive. The functional element 3 with the pre-encapsulation 2c is fixed, e.g., glued, to the surface of the glass pane 1. The glass pane 1 is arranged parallel to and at a distance from a support pane 10, wherein the surface, provided with the functional element 3, of the glass pane 1 faces the support pane 10. The space between the panes forms a cavity. The support pane, for example, is also a 3.5 mm thick pane made of soda lime glass. A separating layer 11, e.g., a Teflon foil, is arranged on the surface, facing the glass pane 1, of the support pane 10.

Subsequently, the cavity or space between the panes is sealed with an edge seal 9 (FIG. 7a)—for example, an adhesive tape. Subsequently, the optically clear adhesive is filled into the cavity and cured. The same adhesive is used as for pre-encapsulation 2c. The pre-encapsulation 2c and the optically clear adhesive filled into the cavity result in the layer 2a of the optically clear adhesive according to the invention, which in turn forms the encapsulation layer 2 (FIG. 7b).

After removing the edge seal 9, the support pane 10 having the separating layer 11 can be removed. The result is a glazing element of the type shown in FIG. 2 (FIG. 7c).

Alternatively, a glazing element with a functional element 3 embedded in the layer 2a can also be produced by arranging the functional element 3 in the cavity or space between the panes, without making contact with the glass pane 1. The functional element 3 can be suspended in the cavity, for example.

The shown embodiments and combinations of features are to be understood merely by way of example and are not intended to limit the invention. Thus, in all embodiments in which the functional element 3 is arranged between the glass pane 1 and the layer 2a, the functional element 3 can alternatively also be embedded in the layer 2a, and vice versa. It is also not necessary that, in cases in which the encapsulation layer 2 is arranged between the glass pane 1 (primary pane) and a further pane 6 (secondary pane), this further glass pane 6 be part of a laminated pane, as in FIGS. 3 and 4. Instead, the further glass pane 6 can also be provided as a single pane, so that its surface facing away from the encapsulation layer 2 forms an external surface of the glazing element. Both the glass pane 1 (primary pane) and the further pane 6 (secondary pane) can also be provided as individual panes, so that their surfaces facing away from one another form the external surfaces of the glazing element. The embodiment of the encapsulation layer 2 as shown in FIG. 4, consisting of thermoplastic foils 2b and layers 2a of optically clear adhesive, can in principle be combined with any structure of the glazing element, in particular with those in which the encapsulation layer 2 is arranged between the glass pane 1 (primary pane) and a further pane 6 (secondary pane). The glass pane 1 and the further glass pane 6 are preferably provided pre-laminated via the foils 2b, and the cavities are then filled with optically clear adhesive.

### LIST OF REFERENCE SIGNS

(1) Glass pane/primary pane
(2) Encapsulation layer
(2a) Layer made of an optically clear adhesive
(2b) Thermoplastic foil (as part of the encapsulation layer 2)
(2c) Pre-encapsulation of the functional element 3 made of an optically clear adhesive
(3) Functional element
(4) Thermoplastic intermediate layer
(5) Further glass pane
(6) Further glass pane/secondary pane
(7) Thermoplastic intermediate layer
(8) Further glass pane
(9) Edge seal
(10) Support pane
(11) Separating layer
(I) (First) external surface of the glazing element
(II) (Second) external surface of the glazing element

1. A glazing element comprising a glass pane or plastic pane and an encapsulation layer on a surface of the glass pane or plastic pane,
wherein the encapsulation layer is formed at least in some regions as a layer of an optically clear adhesive,
and wherein an electrical functional element
is arranged between the layer of the optically clear adhesive and the glass pane or plastic pane
or
is embedded in the layer of the optically clear adhesive.

2. The glazing element according to claim 1, wherein the surface, facing away from the glass pane or plastic pane, of the encapsulation layer forms an external surface of the glazing element.

3. The glazing element according to claim 1, wherein the encapsulation layer is arranged between said glass pane or plastic pane and a further glass pane or plastic pane.

4. The glazing element according to claim 3, wherein the encapsulation layer is formed in some regions as a layer of the optically clear adhesive and in some regions from at least one thermoplastic foil.

5. The glazing element according to claim 1, wherein the encapsulation layer is formed entirely as a layer of the optically clear adhesive.

6. The glazing element according to claim 1, wherein said glass pane or plastic pane is connected to a further glass pane or plastic pane via a thermoplastic intermediate layer.

7. The glazing element according to claim 1, wherein the functional element is
a functional foil with electrically controllable optical properties,
a sensor, or
a light source.

8. The glazing element according to claim 1, wherein the encapsulation layer has a thickness of 0.2 mm to 50 mm.

9. The glazing element according to claim 1, wherein the optically clear adhesive is a 2-component polyurethane adhesive, a 1-component acrylate adhesive, a 1-component silicone adhesive, or a 1-component acrylate hybrid adhesive.

10. A method for producing a glazing element according to claim 2, comprising:
(a) arranging the glass pane or plastic pane and a support pane parallel to and at a distance from one another, so that a cavity is formed between them,
(b) providing the cavity with an edge seal,
(c) filling an optically clear adhesive into the cavity and curing the optically clear adhesive, and
(d) removing the support pane,
wherein the functional element
is arranged on the surface, facing the support pane, of the glass pane or plastic pane prior to method step (a), or
is arranged in the cavity.

11. The method according to claim 10, wherein, on the surface, facing the glass pane or plastic pane, of the support pane, a separating layer is arranged which is suitable for preventing adhesion between the support pane and the optically clear plastic.

12. A method for producing a glazing element according to claim 3, comprising:
(a) arranging the glass pane or plastic pane and the further glass pane or plastic pane parallel to and at a distance from one another, so that a cavity is formed between them,
(b) providing the cavity with an edge seal, and
(c) filling an optically clear adhesive into the cavity and curing the optically clear adhesive,
wherein the functional element
is arranged on the surface, facing the further glass pane or plastic pane, of the glass pane or plastic pane prior to method step (a), or
is arranged in the cavity.

13. The method according to claim 12, wherein the glass pane or plastic pane and the further glass pane or plastic pane are connected to one another in some regions via a thermoplastic foil in method step (a), wherein at least one cavity is formed between them, which cavity is provided with the edge seal in method step (b) in that the space between the panes is provided with the edge seal.

14. The method according to claim 10, wherein the functional element is provided with a pre-encapsulation made of an optically clear adhesive and is arranged on the surface, facing the further glass pane or plastic pane, of the glass pane or plastic pane or is arranged in the cavity.

15. A method comprising providing a laminated pane according to claim 1 in a building or in a vehicle of transportation for traffic on land, in the air, or on water.

16. The glazing element according to claim 7, wherein
the functional foil is an SPD foil, a foil based upon liquid crystal technology, or an electrochromic foil,
the sensor is a light sensor, rain sensor, or temperature sensor, or
the light source is a light-emitting diode.

17. The glazing element according to claim 8, wherein the encapsulation layer has a thickness of 0.5 mm to 2 mm.

18. The method according to claim 11, wherein the separating layer is a Teflon layer or Teflon foil.

19. The method according to claim 15, wherein the laminated pane is a vehicle pane.
